(19) United States
(12) Patent Application Publication
(10) Pub. No.: US 2013/0064337 A1
(43) Pub. Date: Mar. 14, 2013

(54) Method and Apparatus for Adaptive Hysteresis Timer Adjustments for Clock Gating

(71) Applicants: Richard Gerard Hofmann, Cary, NC (US); Jaya Prakash Subramaniam Ganasan, Youngsville, NC (US)

(72) Inventors: Richard Gerard Hofmann, Cary, NC (US); Jaya Prakash Subramaniam Ganasan, Youngsville, NC (US)

(73) Assignee: QUALCOMM Incorporated, San Diego, CA (US)

(21) Appl. No.: 13/229,943

(22) Filed: Sep. 12, 2011

(51) Int. Cl. H04L 7/00

(52) U.S. Cl. 375/354

(57) ABSTRACT

Apparatus and method for adaptive hysteresis timer adjustments for clock gating are disclosed. An apparatus comprises a transaction circuit configured to perform transactions. The apparatus further comprises a hysteresis timer having a hysteresis value and configured to start counting based on the hysteresis value when a transaction in the transaction circuit has been completed. The apparatus further comprises a hysteresis timer update circuit configured to monitor the hysteresis timer and the transaction circuit, store an adjustment state based on whether a new transaction is received before, coincident with or after the count of the hysteresis timer expires and adjust the hysteresis value based on the adjustment state.

### FIELD OF DISCLOSURE

The technology of this disclosure relates to clock gating, and in particular to performing clock gating based on an adaptive hysteresis timer.

### BACKGROUND

Portable electronic devices, such as mobile phones, personal digital assistants (PDAs), and the like, are commonly manufactured using application specific integrated circuit (ASIC) designs. Developments in achieving high levels of silicon integration have allowed creation of complicated ASICs and field programmable gate array (FPGA) designs. These ASICs and FPGAs may be provided in a single chip to provide a system-on-a-chip (SOC). An SOC provides multiple functioning subsystems on a single semiconductor chip, such as for example, processors, multipliers, caches, and other electronic components. SOCs are particularly useful in portable electronic devices because of their integration of multiple subsystems that can provide multiple features and applications in a single chip. Further, SOCs may allow smaller portable electronic devices by use of a single chip that may otherwise have been provided using multiple chips.

Integrated circuits such as those described above may include transaction circuits (such as bus interface circuits or memory controllers, for example). Transaction circuits may facilitate the handling of communications between subsystems of the integrated circuit. The transaction circuits may further include clocked circuitry, which may include as examples registers, queues, and other circuits to manage communications between the various subsystems. The transaction circuits may be clocked with one or more clock signals when servicing transactions. However, continuously clocking the transaction circuits consumes system power even during time periods when the transaction circuits are not servicing transactions, which may be undesirable particularly in mobile systems which rely on battery power or other limited power sources. Thus, it may be desirable to turn off the clocks to the transaction circuits when the transaction circuits are not servicing transactions. However, if a new transaction arrives, a performance penalty may be incurred to turn on the clocks to the respective transaction circuit.

Another approach is to pre-select a fixed number of clock cycles for which the clocks to the transaction circuits remain on after a transaction has been completed. However, due to varying levels of activity for individual transaction circuits, determining a suitable pre-selected number of clock cycles may be difficult and may still involve undesirable tradeoffs in power, performance or both.

### SUMMARY OF THE DISCLOSURE

Exemplary embodiments are directed to apparatus and method for adaptive hysteresis timer adjustments for clock gating. Such embodiments may allow clock gating for an interface circuit to adapt to changing traffic conditions through the interface circuit.

In an exemplary embodiment, an apparatus comprises a transaction circuit configured to perform transactions. The apparatus further comprises a hysteresis timer having a hysteresis value and configured to start counting based on the hysteresis value when a transaction in the transaction circuit has been completed. The apparatus further comprises a hysteresis timer update circuit configured to monitor the hysteresis timer and the transaction circuit, store an adjustment state based on whether a new transaction is received before, coincident with or after the count of the hysteresis timer expires and adjust the hysteresis value based on the adjustment state.

In another exemplary embodiment, a method of adjusting a hysteresis timer comprises monitoring a transaction circuit to detect completion of a transaction and starting a count from a hysteresis value at the hysteresis timer in response to detecting completion of a transaction. The method further comprises monitoring the hysteresis timer while awaiting a new transaction. The method further comprises adjusting the hysteresis value of the hysteresis timer with an adjustment value if the hysteresis timer does not expire coincident with the arrival of the new transaction.

In another exemplary embodiment, an apparatus comprises means for performing transactions and means for counting based on a hysteresis value when the means for performing transactions has completed performing a transaction. The apparatus further comprises means for updating the means for counting. The means for updating is configured to monitor the means for performing transactions and the means for counting, store an adjustment state based on whether a new transaction is received before, coincident with or after the count of the means for counting expires, and adjust the hysteresis value based on the adjustment state.

In another exemplary embodiment, an apparatus comprises a non-transitory computer-readable medium having instructions stored thereon which, when executed, cause a processor to monitor a transaction circuit to detect completion of a transaction and start a count from a hysteresis value at a hysteresis timer in response to detecting completion of a bus transaction. The instructions further cause the processor to monitor the hysteresis timer while awaiting a new bus transaction and adjust the hysteresis value of the hysteresis timer with an adjustment value if the hysteresis timer does not expire coincident with the arrival of the new bus transaction.

It is understood that other embodiments of the teachings herein will become apparent to those skilled in the art from the following detailed description, wherein various embodiments of the teachings are shown and described by way of illustration. As will be realized, the teachings herein are capable of other and different embodiments without departing from the spirit and scope of the teachings. Accordingly, the drawings and detailed description are to be regarded as illustrative in nature and not as restrictive.

### BRIEF DESCRIPTION OF THE DRAWINGS

Various aspects of the teachings of the present disclosure are illustrated by way of example, and not by way of limitation, in the accompanying drawings, wherein:

FIG. 1 is a block diagram of an circuit in accordance with one embodiment;

FIG. 2A is a block diagram of an exemplary hysteresis timer update circuit in accordance with one embodiment;

FIG. 2B is a block diagram of a memory structure for implementing a history table in accordance with another embodiment;

FIG. 3 is a block diagram of a bus interconnect system including an exemplary hysteresis timer update circuit in accordance with one embodiment;

FIG. 4 is a flowchart illustrating a method of using an adaptive hysteresis timer in accordance with one embodiment; and

FIG. 5 is a block diagram of an exemplary processor circuit employing a bus interconnect in accordance with the embodiments described herein.

### DETAILED DESCRIPTION

The detailed description set forth below, in connection with the appended drawings, is intended as a description of various exemplary embodiments of the teachings of the present disclosure and is not intended to represent the only embodiments in which such teachings may be practiced. The detailed description includes specific details for the purpose of providing a thorough understanding of the teachings by way of illustration and not limitation. It will be apparent to those skilled in the art that the teachings of the present disclosure may be practiced in a variety of ways. In some instances, well known structures and components are shown in block diagram form in order to avoid obscuring the concepts of the present disclosure.

Embodiments disclosed in the detailed description include a method and apparatus for adaptive hysteresis timer adjustments for clock gating. In one embodiment, an interface circuit includes a transaction circuit coupled to a history register and to a clock gating circuit. The clock gating circuit is responsive to a hysteresis timer and is configured to turn off, or “gate,” the clock signal to the transaction circuit when the hysteresis timer indicates that a number of clock cycles corresponding to a hysteresis value have passed since the last transaction serviced by the interface circuit was completed. The hysteresis timer is responsive to a timer update circuit, which may provide to the hysteresis timer either a programmed hysteresis value or a hysteresis value determined at least in part by a state of the history register. The hysteresis value determined at least in part by the state of the history register may be determined by adjusting a current hysteresis value with an adjustment value, and the adjustment value may be determined by combinational logic (e.g. by selecting a particular input of a multiplexor), by looking up a value in a history table (e.g. a content-addressable memory (CAM) indexed by the history register) or by other means known to those having skill in the art. The adjustment values may be configurable or may be hard-wired. This allows the clock gating circuit to limit performance degradation of the interface circuit by not gating the clock to the interface circuit when receiving multiple transactions that do not arrive back-to-back but nonetheless occur in close temporal proximity to one another, while still realizing power savings by gating the clock to the interface circuit when no new transaction arrives within a period of time corresponding to the hysteresis value.

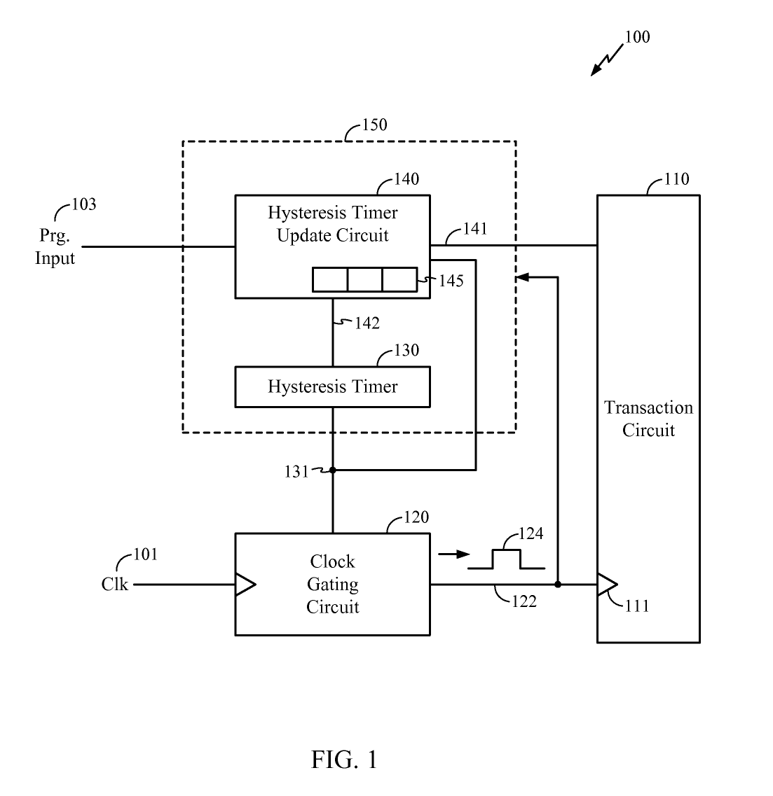

In this regard and in accordance with one embodiment, FIG. 1 illustrates a block diagram of a circuit 100. The circuit 100 includes a transaction circuit 110 for performing transactions. The transaction circuit 110 has a clock input 111 which is coupled to a transaction clock output 122 of a clock gating circuit 120. The clock gating circuit 120 receives a system clock input 101 and is configured to provide a clock signal 124 on the transaction clock output 122, responsive to a hysteresis timer 130. A hysteresis timer update circuit 140 is coupled to the hysteresis timer 130 and to the transaction circuit 110, and comprises a timer history register 145. The hysteresis timer update circuit 140 and the hysteresis timer 130 together form a hysteresis timer circuit 150. The hysteresis timer update circuit 140 and the timer history register 145 may also be responsive to a programming input 103. The hysteresis timer update circuit 140 is configured to monitor transaction activity through the transaction circuit 110 and a state of the hysteresis timer 130. The hysteresis timer update circuit 140 is further configured to update a hysteresis value of the hysteresis timer 130 based on a value stored in the timer history register 145. The hysteresis timer update circuit 140 may be further configured to update the hysteresis value of the hysteresis timer 130 based on a value received via the programming input 103.

The transaction circuit 110 may be configured to perform transactions for a master device, a slave device, a port of a bus interconnect, a memory or any other device which services transactions. The clock input 111 of the transaction circuit 110 is controlled by the clock gating circuit 120, and any transaction activity through the transaction circuit 110 is monitored by the hysteresis timer update circuit 140 in order to provide adaptive adjustments to the hysteresis timer 130. In one exemplary embodiment, the circuit 100 is a bus interface circuit. In such an embodiment, the transaction circuit 110 may implement and operate according to any synchronous bus protocol, such as AMBA AXI, AHB, APB or others. In another exemplary embodiment, the circuit 100 is a memory and the transaction circuit 110 is a memory controller circuit.

The clock gating circuit 120 receives the system clock 101. While the transaction circuit 110 is performing a transaction, the clock gating circuit provides the clock signal 124 on the transaction clock output 122, which is used to clock the transaction circuit 110 and the hysteresis timer circuit 150. After a transaction has been completed, the clock gating circuit monitors the hysteresis timer 130 via a hysteresis timer interface 131. While the hysteresis timer 130 has not expired (meaning that the hysteresis timer 130 has not counted to a terminal count value), the clock gating circuit 120 continues to provide the clock signal 124 to the transaction circuit 110 and the hysteresis timer circuit 150. After the hysteresis timer 130 expires (meaning that the hysteresis timer 130 has counted to a terminal value), the clock gating circuit 120 gates the system clock by, for example, providing a steady state signal on the transaction clock output 122.

The hysteresis timer 130 is programmed with a hysteresis value by the hysteresis timer update circuit 140 via a hysteresis value interface 142. After completion of a transaction in the transaction circuit 110, the hysteresis timer 130 begins counting. If no new transaction is received by the transaction circuit 110 before the hysteresis timer 130 counts for the number of cycles represented by the hysteresis value (representing the terminal count value), the hysteresis timer 130 expires. If a new transaction is received by the transaction circuit 110 before the hysteresis timer 130 counts for the number of cycles represented by the hysteresis value, the hysteresis timer 130 stops and waits to receive a new hysteresis value. Those having skill in the art will readily understand that the hysteresis timer may be made to count either up or down towards the terminal value.

The hysteresis timer update circuit 140 is responsive to a programming input 103 and a transaction activity interface 141. When providing a hysteresis value to the hysteresis timer 130, the hysteresis timer update circuit is configured to select between a programmed hysteresis value received via the programming input 103 (for example, to allow the hysteresis timer 130 to be programmed with an initial value at boot time) and a value determined at least in part by the timer history register 145. The hysteresis timer update circuit 140 may be configured to monitor the transaction circuit 110 via the transaction activity interface 141 and to provide a start signal to the hysteresis timer 130 via a hysteresis value interface 142 when a transaction has been completed. While the hysteresis timer 130 counts towards the terminal count value, the hysteresis timer update circuit 140 is configured to monitor a current state of the hysteresis timer 130 via the hysteresis timer interface 131 and to monitor the transaction circuit 110 for a new transaction via the transaction activity interface 141. For example, if the hysteresis timer 130 expires before a new transaction is received by the transaction circuit 110, this may represent an INCREMENT current state. If the hysteresis timer 130 expires coincident with when a new transaction is received by the transaction circuit 110, this may represent a NO CHANGE current state. If the hysteresis timer 130 does not expire before a new transaction is receive by the transaction circuit 110, this may represent a DECREMENT current state. The hysteresis timer update circuit 140 stores the current state in the timer history register 145 and is configured to update a hysteresis value of the hysteresis timer 130 based on the value(s) stored in the timer history register 145. The timer history register 145 may be a shift register, and may store at least one previous state of the hysteresis timer 130 along with the current state.

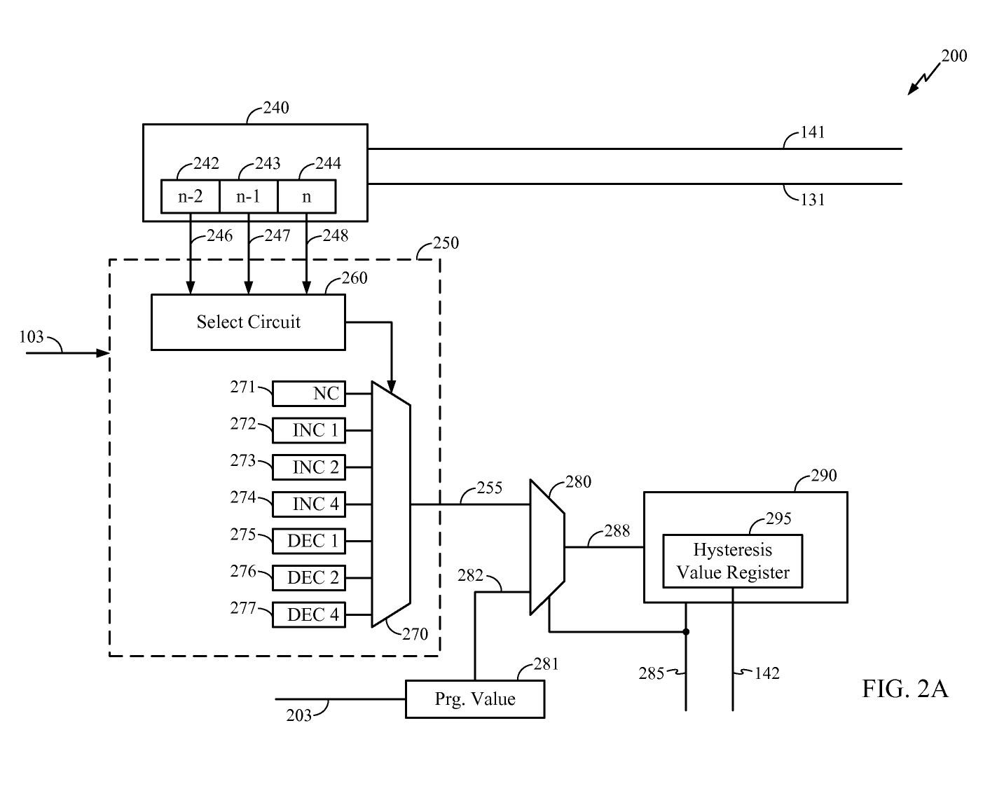

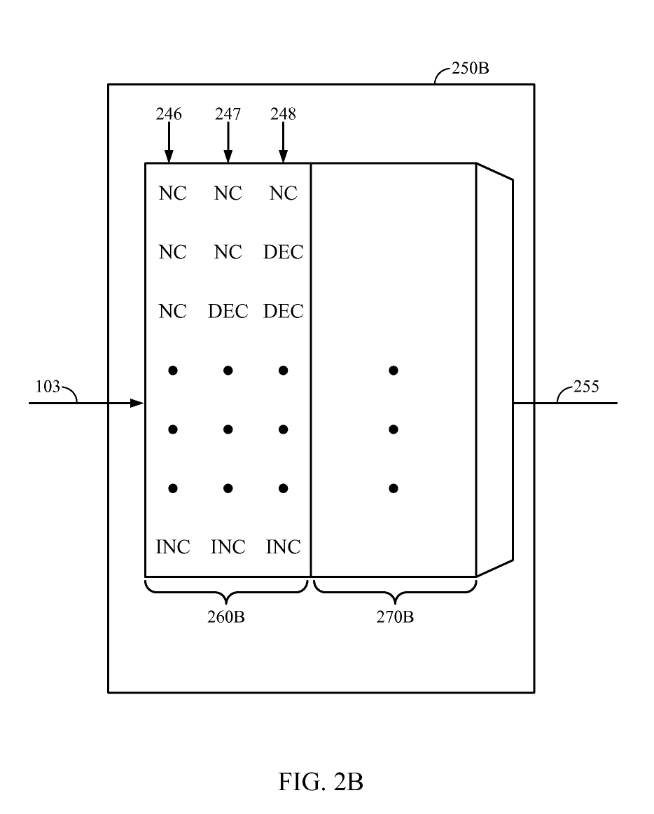

FIG. 2A illustrates a block diagram of an exemplary hysteresis timer update circuit 200. In one embodiment, the hysteresis timer update circuit 200 may be used as the hysteresis timer update circuit 140 of the circuit 100. The hysteresis timer update circuit 200 comprises a hysteresis timer history circuit 240 responsive to the transaction activity interface 141 and the hysteresis value interface 142. The hysteresis timer history circuit 240 comprises hysteresis timer history registers 242-244. A hysteresis timer adjustment selection circuit 250 is coupled to the hysteresis timer history circuit 240 via the hysteresis timer history inputs 246-248, and is configured to produce a selected hysteresis timer adjustment output 255. The hysteresis timer update circuit 200 further comprises a programming input 103 coupled to a programmed value register 281. The programmed value register 281 is configured to produce a programmed value output 282. The selected hysteresis timer adjustment output 255 and the programmed value output 282 are coupled to a multiplexor 280 which is controlled by a hysteresis value select input 285. The multiplexor 280 provides a hysteresis value output 288 to a hysteresis value register adjustment circuit 290, which is configured to adjust a hysteresis value stored in a hysteresis value register 295 based on the hysteresis value output 288 and the hysteresis value select input 285, and to provide the adjusted hysteresis value to the hysteresis timer 130 via the hysteresis value interface 142.

The hysteresis timer history circuit 240 stores a current state and at least one previous state of a hysteresis timer as described above in reference to FIG. 1. To this end, the hysteresis timer history circuit 240 assigns a binary representation to each of the possible adjustment states of the hysteresis timer. For example, in one embodiment “01” corresponds to INCREMENT, “10” corresponds to DECREMENT and “00” corresponds to “NO CHANGE.” In an exemplary embodiment, the hysteresis timer history circuit 240 stores the most recent three adjustment states of the hysteresis timer in hysteresis timer history registers 242-244. However, the invention is not so limited and those skilled in the art will realize that any number of states may be tracked by the hysteresis timer history circuit 240 by changing the number of hysteresis timer history registers depending upon available storage space, chip area and other design considerations. The values stored in hysteresis timer history registers 242-244 are provided to the hysteresis timer adjustment selection circuit 250 via the hysteresis timer history inputs 246-248. For example, if the third most recent state is INCREMENT, the second most recent state is NO CHANGE and the most recent state is NO CHANGE, the value “01,00,00” would be provided via the hysteresis timer history inputs 246-268 to the hysteresis timer adjustment selection circuit 250.

The hysteresis timer adjustment selection circuit 250 comprises a select circuit 260 which controls a multiplexor 270. The multiplexor 270 has data inputs each coupled to one of a plurality of registers 271-277 and a control input coupled to the select circuit 260. Each of the registers 271-277 contains a hysteresis adjustment value that corresponds to a particular state of the hysteresis timer history registers 242-244. In some embodiments, at least a portion of each of the registers 271-277 may include logical “DON′T CARE” states corresponding to the history registers 242-244. For example, register 271 may be programmed with a value of “0” (meaning no adjustment) to correspond with “NO CHANGE” as the most recent state, and “DON′T CARE” for the two next most recent states. Registers 272-274 may contain values of “1,” “2,” and “4” to correspond with the most recent, two most recent and three most recent states being “INCREMENT,” respectively. Likewise, registers 275-277 may contain values of “−1,” “−2,” and “−4” to correspond with the most recent, two most recent and three most recent states being “DECREMENT,” respectively. The select circuit 260 is configured to receive the hysteresis timer history inputs 246-248 from the hysteresis timer history circuit 240 and generate a control signal for the multiplexor 270, which selects one of the registers 271-277 to provide a selected hysteresis timer adjustment output 255 based on the hysteresis timer history inputs 246-248. For example, if the three most recent states of the hysteresis timer history registers 242-244 are all “DECREMENT,” the select circuit 260 receives the values “10,” “10,” and “10” on the hysteresis timer history inputs 246-248 respectively and generates a control signal for the multiplexor 270 which selects register 277 to provide the selected hysteresis timer adjustment output 255. Thus, registers 272-274 may be programmed such that where two or more of the most recent states are the same, the select circuit 260 provides selected hysteresis timer adjustment outputs 255 that have progressively increasing magnitudes or absolute values (for example, two most recent states being “DECREMENT” gives an adjustment value of “−2,” three most recent states being “DECREMENT” gives an adjustment value of “−4,” two most recent states being “INCREMENT” gives an adjustment value of “2” and three most recent states being “INCREMENT” gives an adjustment value of “4”).

The registers 271-277 may be programmable in order to allow the circuit 100 to respond to changing traffic demands. For example, if consecutive adjustment states of the hysteresis timer history registers 242-244 are the same, this may indicate that the value in the hysteresis value register 295 needs to undergo a significant adjustment to respond to a new traffic pattern. In order to allow the value in the hysteresis value register 295 to be adjusted more efficiently in these cases, values with progressively increasing magnitude may be programmed into registers 272-274 (for INCREMENT states) and registers 275-277 (for DECREMENT states) to correspond with consecutive adjustment states of the hysteresis timer history registers 242-244 that are the same. In one embodiment, the values may be exponentially increasing in magnitude. Those having skill in the art will recognize that based on various combinations of states of the hysteresis timer history registers 242-244, different rates of increase in the hysteresis timer update values corresponding to those states may be employed. In some embodiments the values in registers 271-277 may be programmable during operation such that if a first set of values does not provide appropriate adjustments, a new set of values may be programmed without resetting a device containing the circuit 100. Alternatively, in some embodiments the values in registers 271-277 may be hard-coded or otherwise permanently fixed.

The multiplexor 280 receives the selected hysteresis timer adjustment output 255 and the programmed value output 282. Based on the hysteresis value select input 285, the multiplexor 280 provides either the selected hysteresis timer adjustment output 255 or the programmed value output 282 as the hysteresis value output 288 to the hysteresis value register adjustment circuit 290. The hysteresis value register adjustment circuit 290 is configured to adjust the hysteresis value stored in the hysteresis value register 295 based on the hysteresis value output 288 and the hysteresis value select input 285. When the hysteresis value select input 285 indicates that the selected hysteresis timer adjustment output 255 has been selected as the hysteresis value output 288, the hysteresis value register adjustment circuit 290 may perform an arithmetic operation to add to or subtract from a current value of the hysteresis value register 295 based on the hysteresis value output 288 to produce an adjusted hysteresis value. Alternatively, when the hysteresis value select input 285 indicates that the programmed value output 282 has been selected as the hysteresis value output 288, the hysteresis value register adjustment circuit 290 may simply use the programmed value output 282 as the adjusted hysteresis value. In either case, the hysteresis value register adjustment circuit 290 is configured to write the adjusted hysteresis value into the hysteresis value register 295 and provide the adjusted hysteresis value to the hysteresis timer 130 via the hysteresis value interface 142.

FIG. 2B illustrates a memory for implementing a hysteresis value history table 250B. In one embodiment, the memory 250B may be a content-addressable memory (CAM) and may be employed in place of the hysteresis timer adjustment selection circuit 250 of FIG. 2A.

The memory 250B includes a compare section 260B and a data section 270B. The memory 250B further includes the hysteresis timer history inputs 246-248 coupled to the compare section 260B and the selected hysteresis timer adjustment output 255. The memory 250B may include the programming input 103 for programming the compare section 260B and reset inputs (not shown) for initializing the memory 250B, along with any other features commonly employed in CAM structures by those having skill in the art.

Each row of the compare section 260B comprises a plurality of entries, and each entry corresponds to a state of the hysteresis timer history registers 242-244. Although compare section 260B is illustrated as having three entries per row, those having skill in the art will recognize that each row may have as few or as many entries as desired. Each row of the compare section 260B corresponds to a row of the data section 270B. Each row of the data section 270B contains a hysteresis adjustment value that is associated with the states of the hysteresis timer history registers 242-244 represented by the corresponding row of the compare section 260B.

The memory 250B receives the hysteresis timer history inputs 246-248 at the compare section 260B, and performs a lookup operation. If the lookup operation results in a hit, the memory 250B provides a corresponding hysteresis adjustment value on the selected hysteresis timer adjustment output 255. If the lookup operation results in a miss, the memory 250B may be configured to provide a zero value on the selected hysteresis timer adjustment output 255. In either case, the value provided on the selected hysteresis timer adjustment output 255 may then be processed in a similar manner as described in FIG. 2A.

The memory 250B of FIG. 2B may provide greater granularity of adjustment of an associated hysteresis timer and increased configurability at the cost of increased silicon area compared to the hysteresis timer adjustment selection circuit 250 of FIG. 2A. Conversely, the hysteresis timer adjustment selection circuit 250 of FIG. 2A may be simpler to design and may be capable of operating at faster speeds than the memory 250B of FIG. 2B. Those having skill in the art will recognize that design considerations such as available silicon area, a desired speed of determining an adjustment and other considerations will determine which approach is more desirable in a particular embodiment. Likewise, with either approach in some embodiments it may be desirable to program maximum and minimum hysteresis timer values that may not be exceeded either by adjusting the hysteresis timer value, by programming a hysteresis timer value or both.

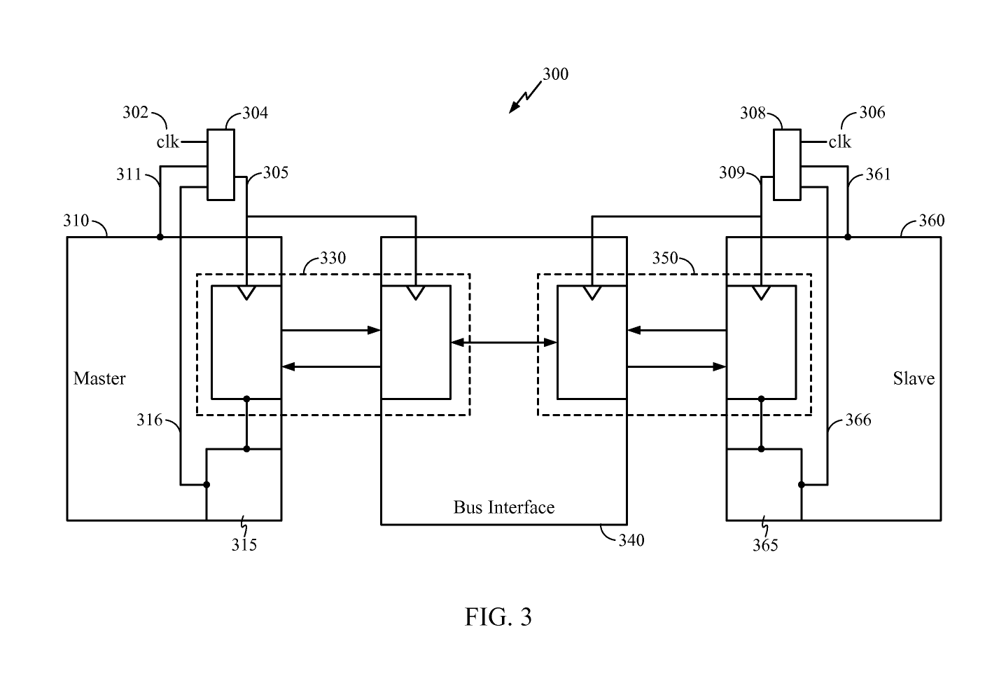

FIG. 3 illustrates a block diagram of a bus system 300 in which the previously-described hysteresis timer circuit may be employed. The bus system 300 includes a master 310 coupled to a slave 360 through a bus interconnect 340. The master 310 is coupled to the bus interconnect 340 through a master transaction circuit 330, and the slave 360 is coupled to the bus interconnect 340 through a slave transaction circuit 350.

The master 310 includes a master hysteresis timer circuit 315. The master transaction circuit 330 receives master clock signal 305 from a master clock enable circuit 304. A master hysteresis timer circuit 315 monitors the master transaction circuit 330 and provides a master clock gating signal 316 to the master clock enable circuit 304. In an exemplary embodiment, the master hysteresis timer circuit 315 may be the hysteresis timer circuit 150 of FIG. 1, and may further include the hysteresis timer update circuit 200 of FIG. 2A or the memory 250B of FIG. 2B. The master clock enable circuit 304 receives a master clock input 302 and provides a master clock output 305 to the master transaction circuit 330, responsive to a master clock enable input 311 and the master clock gating signal 316 provided by the master hysteresis timer circuit 315.

The slave transaction circuit 350 receives slave clock signal 309 from a slave clock enable circuit 308. A slave hysteresis timer circuit 365 monitors transactions on the slave transaction circuit 350 and provides a slave clock gating signal 366 to the slave clock enable circuit 308. In an exemplary embodiment, the slave hysteresis timer circuit 365 may be the hysteresis timer circuit 150 of FIG. 1, and may further include the hysteresis timer update circuit 200 of FIG. 2A or the memory 250B of FIG. 2B. The slave clock enable circuit 308 receives a slave clock input 306 and provides a slave clock output 309 to the slave transaction circuit 350, responsive to a slave clock enable input 361 and the slave clock gating signal 366 provided by the slave hysteresis timer circuit 365.

During operation of the bus system 300, the master hysteresis timer circuit 315 monitors transactions in the master transaction circuit 330 and is configured to gate the master clock output 305 through the master clock enable circuit 304 after a master hysteresis timer associated with the master hysteresis timer circuit 315 expires. Likewise, the slave hysteresis timer circuit 365 monitors transactions in the slave transaction circuit 350 and is configured to gate the slave clock output 309 after a slave hysteresis timer associated with the slave hysteresis timer circuit 365 expires. Gating the master clock output 305 and the slave clock output 309 may reduce power consumption by the bus system 300 when the bus system 300 is not servicing a transaction. Either or both of the master hysteresis timer circuit 315 and the slave hysteresis timer circuit 365 may be programmable in accordance with earlier described embodiments.

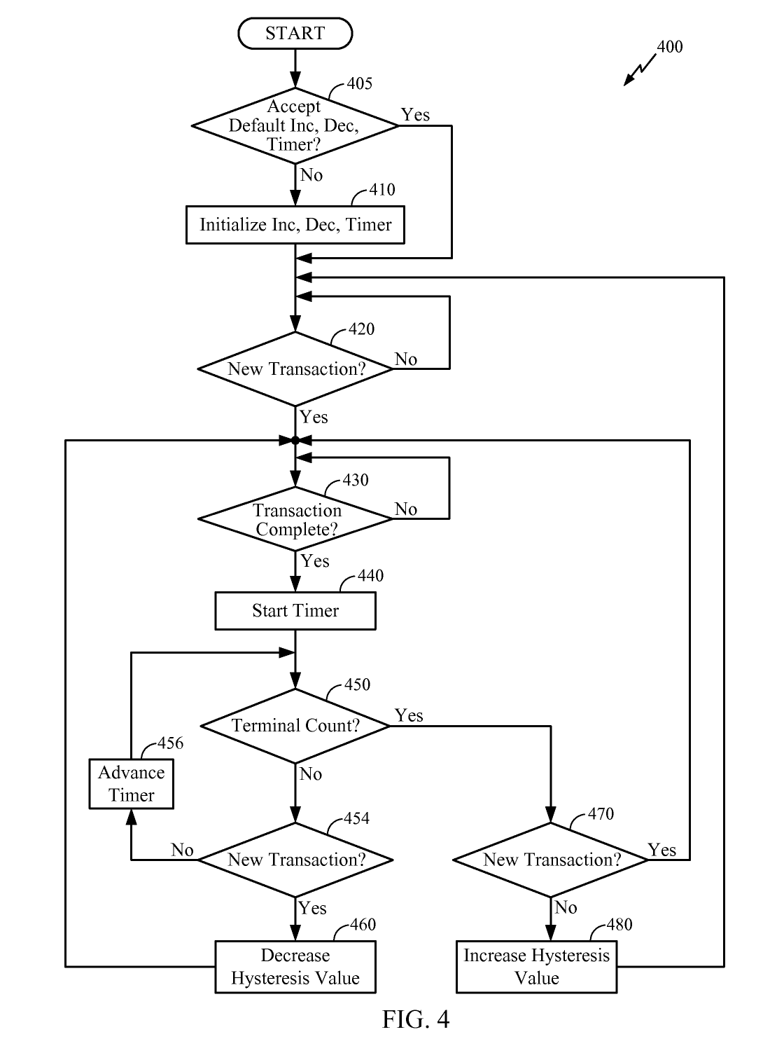

FIG. 4 illustrates a method of using an adaptive hysteresis timer in accordance with one embodiment, generally designated 400. In an exemplary embodiment, the method may be employed by the interface circuits of FIG. 3.

The method 400 starts at block 405 in which a determination is made whether or not to accept default increment, decrement and hysteresis timer values. Default values may be established by fusing, strapping, preprogramming into non-volatile memory or other means known to those skilled in the art. If the default values are acceptable, the method proceeds to block 420. If the default values are not acceptable, the method proceeds to block 410.

In block 410, the increment and decrement values and the hysteresis timer are initialized. For example, the registers 271-277 of FIG. 2A may be programmed with hysteresis adjustment values and the hysteresis timer 130 of FIG. 1 may be programmed with an initial hysteresis value. The method then proceeds to block 420 to await a new transaction.

In block 420, a hysteresis timer update circuit monitors a transaction circuit for a new transaction. For example, the hysteresis timer update circuit 140 of FIG. 1 monitors the transaction circuit 110. If a new transaction is not received, the method remains in block 420. If a new transaction is received, the method proceeds to block 430.

In block 430, the hysteresis timer update circuit monitors the transaction circuit to determine when the transaction has completed. If the transaction (and any other subsequent transactions received while waiting for the transaction to complete) have not completed, the method returns to block 430 and the hysteresis timer update circuit continues to monitor the transaction circuit. When the transaction is completed, the method proceeds to block 440. In block 440, the hysteresis timer is started and the hysteresis timer update circuit awaits a new transaction. For example, hysteresis timer 130 begins counting down while the hysteresis timer update circuit 140 monitors the transaction circuit 110 for a new transaction.

The method then proceeds to block 450, in which the hysteresis timer is checked to determine if it has reached a terminal count value. In an exemplary embodiment, the terminal count value may be zero. If the terminal count value has not yet been reached, the method proceeds to block 454, where the hysteresis timer update circuit determines if a new transaction has been received by the transaction circuit in a current clock cycle. If a new transaction has not been received at the transaction circuit, the method proceeds to block 456 where the hysteresis timer is advanced towards its terminal count value and then returns to block 450. If a new transaction has been received at the transaction circuit, the method proceeds to block 460.

In block 460, the hysteresis timer is stopped because a new transaction has been received and the hysteresis value is decreased because the hysteresis timer did not reach its terminal count before a new transaction was received, indicating that the previous hysteresis value was too large. For example, the hysteresis timer update circuit 140 checks the state of the hysteresis timer 130. The hysteresis timer update circuit 140 then decreases the hysteresis value of the hysteresis timer 130 as described in reference to FIG. 1, 2A or 2B. The method then proceeds to block 430 to await completion of all received transaction.

In block 470, the hysteresis timer update circuit determines if a new transaction has been received by the transaction circuit in a current clock cycle. If a new transaction has been received at the transaction circuit, the hysteresis value is correct because the new transaction was received during the same clock cycle in which the hysteresis timer reached its terminal count. Thus, no adjustment of the hysteresis value is necessary, and the method proceeds to block 430 to await completion of all received transactions. If a new transaction has not been received at the transaction circuit during the clock cycle in which the hysteresis timer reaches its terminal count, the hysteresis timer expires and the method proceeds to block 480.

In block 480, the hysteresis value is increased because the hysteresis timer expired before a new transaction was received, indicating that the previous hysteresis value was not large enough. For example, the hysteresis timer update circuit 140 checks the state of the hysteresis timer 130. The hysteresis timer update circuit 140 then increases the hysteresis value of the hysteresis timer 130 as described in reference to FIG. 1, 2A or 2B. The method then proceeds to block 420 to await a new transaction.

The method 400 may further include checking that a decrease or increase of the hysteresis value (as in blocks 460 and 480) will not cause the hysteresis value to exceed minimum or maximum values. If a decrease or increase of the hysteresis value would cause the hysteresis value to exceed a minimum or maximum value, the decrease or increase of the hysteresis value may be suppressed and the method may return to block 430 or 420, respectively.

Those having skill in the art will recognize that the teachings of this disclosure may be applied to other types of transaction circuits. For example, the teachings may be applied to a memory controller circuit which receives read and write memory transactions and is configured to control a memory array to perform those transactions. In such an embodiment, the hysteresis timer may be applied to determine when particular memory banks may be held open to await new transactions and when those memory banks should be closed, as an example.

The circuit, systems and methods of adaptive hysteresis timer adjustments for clock gating according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

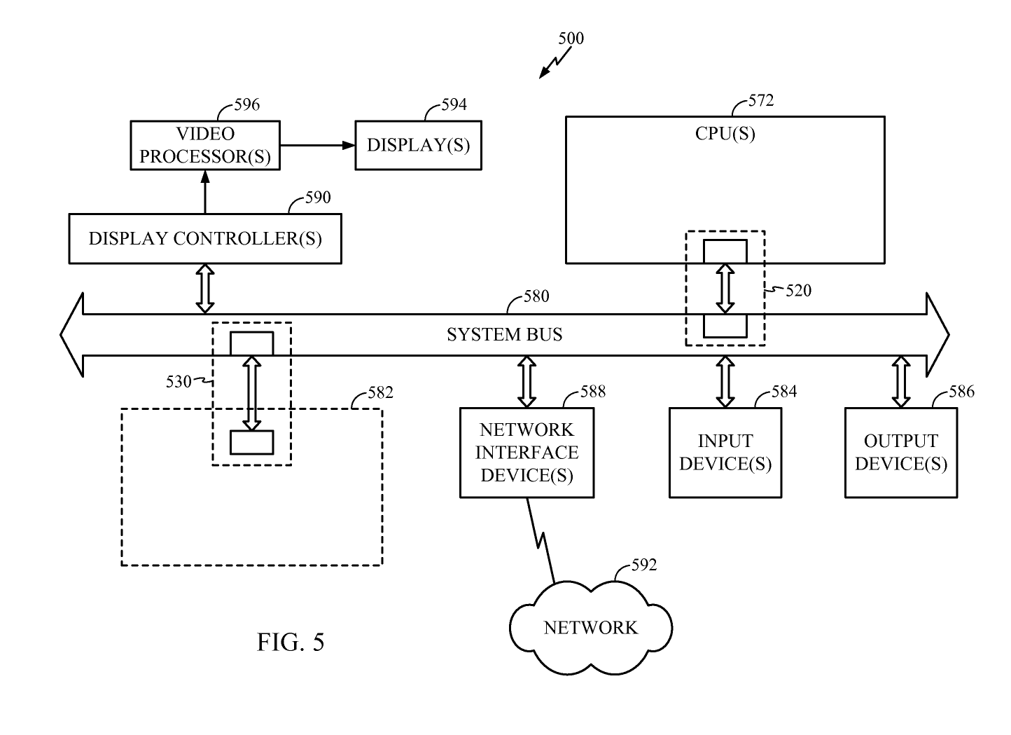

In this regard, FIG. 5 illustrates an example of a processor-based system 500 that can employ components of the circuit 100 illustrated in FIG. 1. In this example, the processor-based system 570 includes one or more central processing units (CPUs) 572. The CPU(s) 572 may be the master device 310 of FIG. 3. The CPU(s) 572 is coupled to a bus interconnect 580 via a master interface circuit 520, which in one embodiment may be the circuit 100 of FIG. 1. The bus interconnect 580 may be the bus interconnect 340 illustrated in FIG. 3. As is well known, the CPU(s) 572 communicates with other devices by exchanging address, control, and data information over the bus interconnect 580. For example, the CPU(s) 572 can communicate bus transaction requests to the memory 582, which may be the slave device 360 of FIG. 3. The memory 582 is coupled to the bus interconnect 580 via a slave interface circuit 530, which in one embodiment may comprise the circuit of FIG. 1.

Other master and slave devices can be connected to the bus interconnect 580. As illustrated in FIG. 5, these devices can include the memory 582, one or more input devices 584, one or more output devices 586, one or more network interface devices 588, and one or more display controllers 590, as examples. The input device(s) 584 can include any type of input device, including but not limited to input keys, switches, voice processors, etc. The output device(s) 586 can include any type of output device, including but not limited to audio, video, other visual indicators, etc. The network interface device(s) 588 can be any devices configured to allow exchange of data to and from a network 592. The network 592 can be any type of network, including but not limited to a wired or wireless network, private or public network, a local area network (LAN), a wide local area network (WLAN), and the Internet. The network interface device(s) 588 can be configured to support any type of communication protocol desired. Although only the CPU 572 and the memory 582 are illustrated as being coupled to the bus interconnect 580 via the interface circuit of FIG. 1 for purposes of clarity, any of the master and slave devices may be so coupled to the bus interconnect 580.

The CPU 572 may also be configured to access the display controller(s) 590 over the bus interconnect 580 to control information sent to one or more displays 594. The display controller(s) 590 sends information to the display(s) 594 to be displayed via one or more video processors 596, which process the information to be displayed into a format suitable for the display(s) 594. The display(s) 594 can include any type of display, including but not limited to a cathode ray tube (CRT), a liquid crystal display (LCD), a plasma display, etc.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The arbiters, master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An apparatus, comprising:
a transaction circuit configured to perform transactions;
a hysteresis timer having a hysteresis value and configured to start counting based on the hysteresis value when a transaction in the transaction circuit has been completed; and
a hysteresis timer update circuit configured to:
monitor the hysteresis timer and the transaction circuit;
store an adjustment state based on whether a new transaction is received before, coincident with or after the count of the hysteresis timer expires; and
adjust the hysteresis value based on the adjustment state.

2. The apparatus of claim 1 further comprising a clock gating circuit configured to receive a clock input and selectively provide a transaction circuit clock signal to the transaction circuit after a transaction has been completed responsive to the hysteresis timer.

3. The apparatus of claim 2, wherein the clock gating circuit is configured to gate the transaction clock signal to the transaction circuit after the hysteresis timer has expired.

4. The apparatus of claim 1, wherein the hysteresis timer update circuit stores a current adjustment state and a previous adjustment state, and wherein the current adjustment state and the previous adjustment state are selected from the group consisting of INCREMENT, NO CHANGE and DECREMENT.

5. The apparatus of claim 4, wherein the hysteresis timer update circuit comprises:
a timer history register configured to store a plurality of adjustment states of the count of the hysteresis timer including the current adjustment state and the previous adjustment state;
a hysteresis value register configured to store the hysteresis value;
an adjustment selection circuit configured to provide an adjustment output based on the plurality of adjustment states; and
an adjustment circuit configured to adjust the hysteresis value based on adjustment output.

6. The apparatus of claim 5 further comprising a select circuit configured to produce a select output based on the plurality of adjustment states and wherein the adjustment selection circuit is a multiplexor having a plurality of data inputs each coupled to one of a plurality of registers and controlled by the select output, wherein the select output causes the multiplexor to provide a value from one of the plurality of registers as the adjustment output.

7. The apparatus of claim 6, wherein the plurality of registers are programmable.

8. The apparatus of claim 5, wherein the adjustment selection circuit comprises a content-addressable memory having a compare section with a plurality of rows and a data section with a plurality of rows, wherein each row of the compare section is associated with a row of the data section, and wherein the content-addressable memory is configured to:
perform a lookup in the compare section based on the plurality of adjustment states;
when the lookup results in a hit in a row of the compare section, provide a value stored in the associated row of the data section as the adjustment output; and
when the lookup results in a miss, provide a zero value as the adjustment output.

9. The apparatus of claim 8, wherein each row of the compare section contains a plurality of possible hysteresis timer history register logical values, and wherein each of the plurality of possible hysteresis timer history register logical values comprises a state selected from the group consisting of INCREMENT, NO CHANGE and DECREMENT.

10. The apparatus of claim 8, wherein each row of the compare section and each associated row of the data section are programmable.

11. The apparatus of claim 5, wherein the hysteresis timer update circuit further comprises a programming input, and wherein the hysteresis timer update circuit is configured to write a value received via the programming input into the hysteresis value register.

12. The apparatus of claim 5, wherein the adjustment circuit comprises an arithmetic logic unit and wherein the adjustment circuit is configured to adjust the hysteresis value by adding to or subtracting from the hysteresis value based on the adjustment output.

13. The apparatus of claim 1, wherein consecutive most recent adjustment states of the hysteresis timer having a same value cause the hysteresis value to be adjusted by progressively greater magnitudes as a number of consecutive adjustment states of the hysteresis timer having the same value increases.

14. The apparatus of claim 13, wherein the adjusting by progressively greater magnitudes comprises an exponential increase in magnitudes.

15. The apparatus of claim 1 further comprising one of a bus interface circuit and a memory controller, into which the apparatus is integrated.

16. The apparatus of claim 1 further comprising one of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player, into which the apparatus is integrated

17. A method of adjusting a hysteresis timer, comprising:
monitoring a transaction circuit to detect completion of a transaction;
starting a count from a hysteresis value at the hysteresis timer in response to detecting completion of a transaction;
monitoring the hysteresis timer while awaiting a new transaction; and
adjusting the hysteresis value of the hysteresis timer with an adjustment value if the hysteresis timer does not expire coincident with the arrival of the new transaction.

18. The method of claim 17, further comprising selecting the adjustment value by controlling a multiplexor to select a value in one of a plurality of registers based on a plurality of previous adjustment states of the hysteresis timer.

19. The method of claim 18, further comprising programming the plurality of registers.

20. The method of claim 17, further comprising selecting the adjustment value by providing a plurality of previous adjustment states as an index to a content-addressable memory and performing a lookup operation which causes the content-addressable memory to provide the adjustment value.

21. The method of claim 20, further comprising programming the content-addressable memory.

22. The method of claim 17, further comprising initializing the hysteresis value of the hysteresis timer in response to a hysteresis timer programming input.

23. The method of claim 17, wherein a first adjustment value having a first magnitude is applied to the hysteresis value when a current adjustment state has a current value and a first previous adjustment state has a first previous value different from the current value, and wherein a second adjustment value having a second magnitude is applied to the hysteresis value when the current value and the first previous value are the same and a second previous adjustment state has a second previous value different from the current value and the first previous value, wherein the second magnitude is greater than the first magnitude.

24. The method of claim 23, wherein a third adjustment value having a third magnitude is applied to the hysteresis value when the current value, the first previous value and the second previous value are the same, wherein the third magnitude is greater than the second magnitude.

25. The method of claim 23, wherein the relationship between the first magnitude and the second magnitude is an exponential relationship.

26. The method of claim 17, wherein adjusting the hysteresis value of the hysteresis timer comprises adding to or subtracting from the hysteresis value based on the adjustment value.

27. The method of claim 17, wherein adjusting the hysteresis value of the hysteresis timer comprises:
setting the hysteresis value to a maximum value if adding to the hysteresis value would cause the hysteresis value to exceed the maximum value; and
setting the hysteresis value to a minimum value if subtracting from the hysteresis value would cause the hysteresis value to fall below the minimum value.

28. The method of claim 17, further comprising not adjusting the hysteresis value of the hysteresis timer if the hysteresis timer expires coincident with the arrival of the new bus transaction.

29. An apparatus, comprising:
means for performing transactions;
means for counting based on a hysteresis value when the means for performing transactions has completed performing a transaction; and
means for updating the means for counting, the means for updating configured to:
monitor the means for performing transactions and the means for counting;
store an adjustment state based on whether a new transaction is received before, coincident with or after the count of the means for counting expires; and
adjust the hysteresis value based on the adjustment state.

30. An apparatus comprising a non-transitory computer-readable medium having instructions stored thereon which, when executed, cause a processor to:
monitor a transaction circuit to detect completion of a transaction;
start a count from a hysteresis value at a hysteresis timer in response to detecting completion of a bus transaction;
monitor the hysteresis timer while awaiting a new bus transaction; and
adjust the hysteresis value of the hysteresis timer with an adjustment value if the hysteresis timer does not expire coincident with the arrival of the new bus transaction.
